(19) United States
(12) Patent Application Publication
(10) Pub. No.: US 2009/0001195 A1
(43) Pub. Date: Jan. 1, 2009

(54) Elevated sprinkler system for a building

(76) Inventor: Mikel A. Blank, Ooltewah, TN (US)

Correspondence Address: Mikel A. Blank, 4402 Wellesley Drive, Ooltewah, TN, 37363, US

(21) Appl. No.: 12/215,559

(22) Filed: Jun. 28, 2008

Related U.S. Application Data
(60) Provisional application No. 60/937,951, filed on Jun. 29, 2007.

(51) Int. Cl. B05B 15/00

(52) U.S. Cl. 239/208

(57) ABSTRACT

A sprinkler system is for projecting a liquid from a source onto ground adjacent to a building, the ground having an upper surface. The sprinkler system includes a fluid line coupled with the liquid source and having a flow passage and a nozzle coupled with the fluid line. The nozzle has a discharge port and is fluidly connected with the flow passage such that liquid in the passage flows through the discharge port. The nozzle and/or the fluid line are/is configured to couple with the building such that the nozzle discharge port is spaced generally vertically above the ground upper surface. Preferably, at least one coupler configured to connect the pipe and/or the nozzle with the building such that the nozzle is spaced a substantial vertical distance above the ground upper surface. Further, the nozzle is configured to direct liquid discharged from the flow line generally onto the ground.

This application claims priority to U.S. Provisional Application Ser. No. 60/937,951, filed Jun. 29, 2007, the entire contents of which are incorporated herein by reference.

The present invention relates to sprinkler systems, and more particularly to sprinkler systems for projecting liquid onto ground about a building.

Sprinkler systems for projecting a liquid, such as water or fertilizer, onto ground about a building (e.g., a house) are generally known. Such systems typically include a plurality of pipes installed below ground, typically by digging a series of trench in a lawn, and plurality of nozzles or “sprinkler heads” connected with the pipes. Generally, the nozzles/sprinkler heads are arranged so as to either permanently extend, or are constructed to move or extend, a short distance above the ground upper surface and to project the liquid within a pattern about the nozzle so as to “water” the grass or other plant life surrounding the nozzle.

### SUMMARY OF THE INVENTION

In one aspect, the present invention is a sprinkler system for projecting a liquid from a source onto ground adjacent to a building, the ground having an upper surface. The sprinkler system basically comprises a fluid line coupled with the liquid source and having a flow passage and a nozzle coupled with the fluid line. The nozzle has a discharge port and is fluidly connected with the flow passage such that liquid in the passage flows through the discharge port. The nozzle and/or the fluid line are/is configured to couple with the building such that the nozzle discharge port is spaced generally vertically above the ground upper surface, the nozzle being configured to direct liquid discharged from the flow line generally onto the ground.

In another aspect, the present invention is again a sprinkler system for projecting a liquid from a source onto ground about a building, the ground having an upper surface. The sprinkler system basically comprises a fluid line coupled with the liquid source and having a flow passage and a nozzle coupled with the fluid line. The nozzle has a discharge port and is fluidly connected with the flow passage such that liquid in the passage flows through the discharge port, the nozzle being configured to direct liquid discharged from the flow line generally onto the ground. Further, at least one coupler is configured to connect the pipe and/or the nozzle with the building such that the nozzle is spaced a substantial vertical distance above the ground upper surface.

In a further aspect, the present invention is a homestead comprising a lot including ground with an upper surface and grass on the ground upper surface, a building disposed on the lot, and a sprinkler system including a fluid line coupled with a liquid source and having a flow passage and a nozzle coupled with the fluid line. The nozzle has a discharge port and is fluidly connected with the flow passage such that liquid in the passage flows through the discharge port. The nozzle and/or the fluid line are/is configured to couple with the building such that the nozzle discharge port is spaced generally vertically above the ground upper surface, the nozzle being configured to direct liquid discharged from the flow line generally onto the grass.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a top plan view of a building and surrounding ground, showing sprinkler system in accordance with the present invention installed about the perimeter thereof;

FIG. 2 is a partly broken-away, elevational view of the building and sprinkler system, showing a single nozzle of the sprinkler system;

FIG. 3 is an enlarged, top plan view of the building and sprinkler system;

FIG. 4 is a greatly enlarged, partly broken-away perspective view of a portion of the sprinkler system and a gutter of the building;

FIG. 5 is more enlarged view of a portion of FIG. 4, showing a single nozzle provided by a preferred sprinkler head, a portion of a main pipe of the fluid line and a riser coupling the nozzle with the main pipe;

FIG. 6 is a partly exploded view of the sprinkler head and fluid line components of FIG. 5;

FIG. 7 is a side elevational view of rotor sprinkler head providing a nozzle, showing the sprinkler disposed within the gutter and with an alternative structure for connecting the nozzle to the gutter;

FIG. 8 is a side elevational view of a pop-up sprayer sprinkler head providing a nozzle, shown with the fluid line and nozzle disposed within the gutter and/or a gutter guard;

FIG. 9 is alternative construction of the sprinkler system, shown with the fluid line directly mounted to the building;

FIG. 10 is another alternative construction of the sprinkler system, shown with the fluid line directly mounted to the building;

FIG. 11 is an enlarged, broken-away top plan view of one nozzle of the sprinkler system, showing a fluid stream pattern with a first, relatively larger angle of divergence and stream width;

FIG. 12 is an enlarged, broken-away top plan view of one nozzle of the sprinkler system, showing a fluid stream pattern with a second, relatively lesser angle of divergence and stream width;

FIG. 13 is an enlarged, broken-away top plan view of one nozzle of the sprinkler system, showing the nozzle discharging liquid at a first angular position about a vertical axis;

FIG. 14 is an enlarged, broken-away top plan view of one nozzle of the sprinkler system, showing the nozzle discharging liquid at a second angular position about a vertical axis;

FIG. 15 is a top plan view of the sprinkler system, building and ground, showing the sprinkler system in use;

FIG. 16 is a side elevational view of a portion of the sprinkler system, showing a single nozzle in use;

FIG. 17 is a side elevational view of a pop-up sprinkler head providing a nozzle, showing the nozzle at least partially disposed within the gutter and with a main portion of the fluid line mounted more directly to the building; and

FIG. 18 is a partly-broken away, perspective view of an oscillating spray bar providing a plurality of nozzles, showing the spray bar disposed within a gutter.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

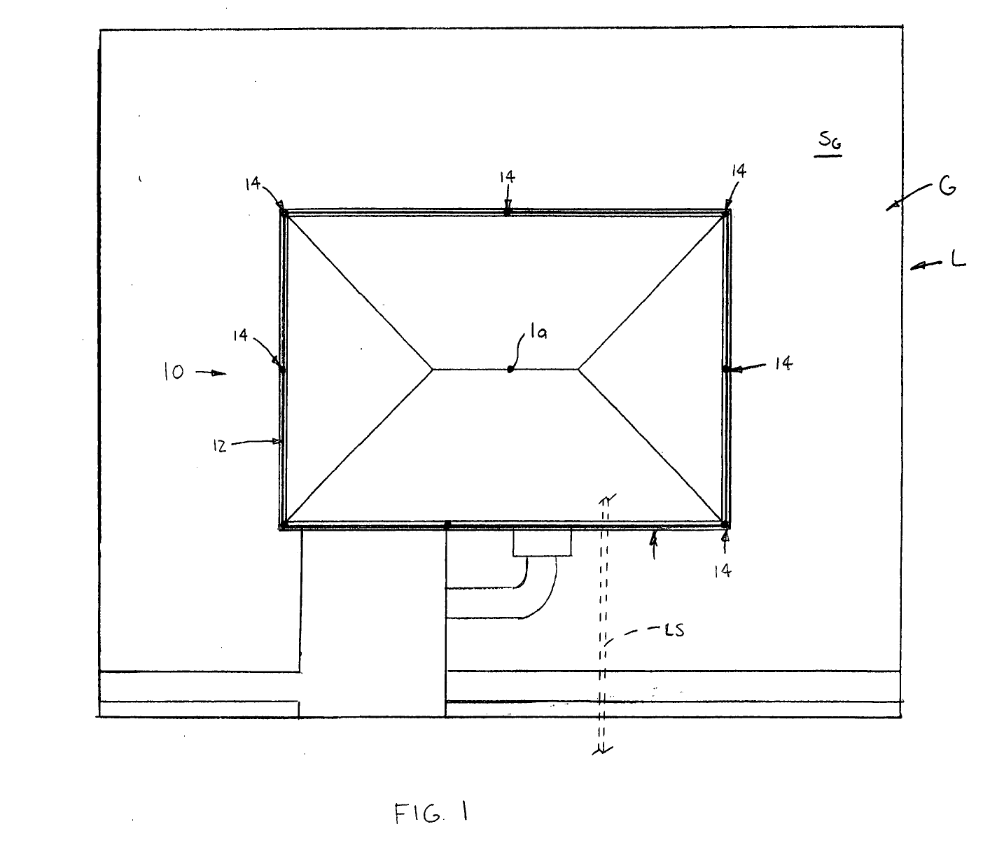

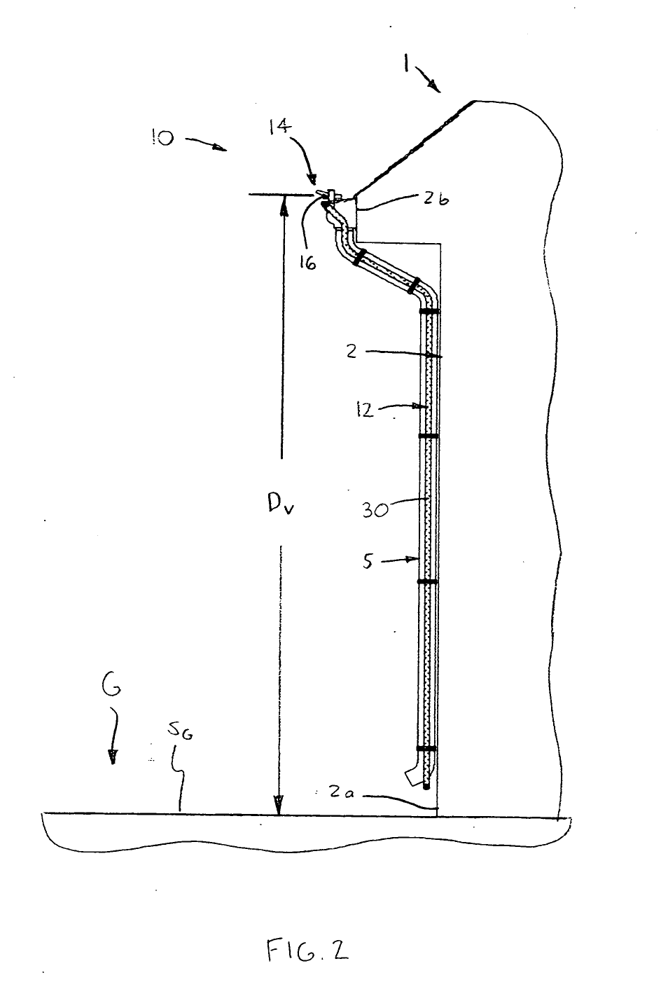

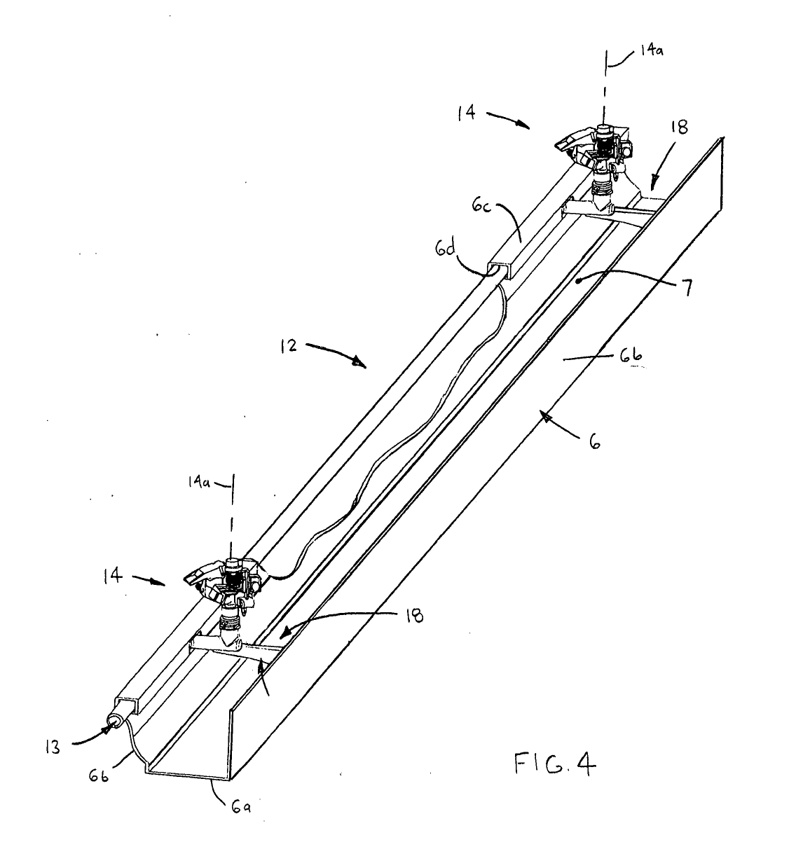

Referring now to the drawings in detail, wherein like numbers are used to indicate like elements throughout, there is shown in FIGS. 1-18 an elevated sprinkler system 10 for projecting a liquid L from a source LS (FIG. 1) onto ground G adjacent to a building 1, the ground G having an upper surface S_{G}. Preferably, the building 1 is a house on a lot L providing the ground G, such that the building 1 and ground G comprise a “homestead”, with at least portion of the ground upper surface S_{G} being covered with grass and/or other vegetation (not depicted). The elevated sprinkler system 10 basically comprises a fluid line 12 coupled with the liquid source LS and having a flow passage 13 (FIGS. 4-6) and at least one and preferably a plurality of nozzles 14 coupled with the fluid line 12. Each nozzle 14 has a discharge port 16 and is fluidly connected with the flow passage 12 such that liquid L in the passage 13 flows through the discharge port 16. The nozzle(s) 14 and/or the fluid line 12 is/are configured to couple or connect with the building 1 such that the nozzle discharge port 16 is spaced generally vertically above the ground upper surface S, preferably by a substantial vertical distance D_{V} (see FIG. 2), as discussed below. As such, each nozzle 14 is configured to direct liquid L discharged from the flow line 12 generally outwardly away from the building 1 so as to thereafter fall onto/upon the ground G.

As discussed above, the ground G preferably includes or is at least partially covered with grass and/or other vegetation and the liquid source LS is preferably a water source (e.g., a city water supply line as depicted in FIG. 1). In such constructions, the fluid line 12 is fluidly coupled with the water source LS and the nozzle(s) 14 is/are configured to project water onto the grass. Although the liquid L is preferably water or water mixed with a substance to promote growth of the grass and/or other vegetation (e.g., fertilizer, weed killer, etc.), the liquid L may alternatively be any other appropriate substance, with the liquid source LS being a supply of any such liquid. For example, the liquid L may be a fire retardant chemical for use in extinguishing fires, which would be particularly suited for use on a building 1 located in an area prone to wildfires, a liquid cleanser for periodic cleaning of the ground G (e.g., when the ground includes pavement), etc.

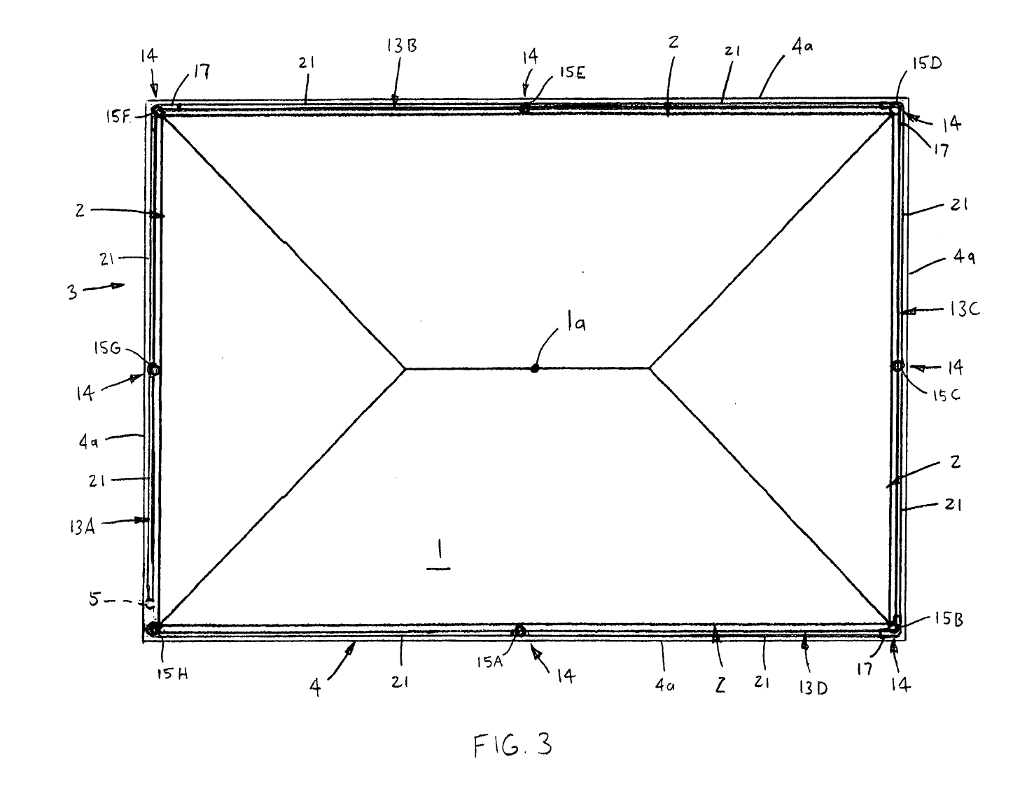

Referring to FIGS. 1, 3 and 15, the building 1 has a center 1a and the fluid line 12 preferably extends at least partially about the building center 1a, and most preferably generally circumferentially and substantially entirely about the center 1a, i.e., about substantially the entire building perimeter. Preferably, the sprinkler system 10 comprises a plurality of the nozzles 14 spaced generally horizontally apart and generally circumferentially about the building center 1a, each nozzle 14 being configured to discharge the liquid L generally away from the building center 1a (i.e., and onto the adjacent ground G), as best shown in FIG. 15. More specifically, the building 1 has a plurality of walls 2 extending generally circumferentially or perimeterically about the center 1a and the fluid line 12 preferably includes a plurality of sections 13N, for example four sections 13A, 13B, 13C and 13D (see FIG. 3), each extending generally horizontally along or about a separate one of the walls 2 and connected with at least one adjacent fluid line section 13N by an elbow 17. The fluid line 12 may extend each one of all of the walls 2 so as to substantially encircle or enclose the building 1, as shown in FIGS. 1, 3 and 15, or may extend along only one or more sections/portions of the building perimeter (not depicted).

With a multi-section fluid line 12, the sprinkler system 10 preferably includes at least one and preferably a plurality of nozzles 14 each coupled with, and spaced apart generally horizontally along, each one of the fluid line sections 13N. For example, each fluid line section 13N may include a single, “central” nozzle 14 and two “end” nozzles 14, with the fluid line 12 being constructed such that each adjacent pairs of fluid line sections, i.e., sections 13A/13B, sections 13B/13C, sections 13C/13D and sections 13D/13A, each sharing a common end nozzle 14, such end nozzles 14 being positioned generally at the corners of the building 1 as best shown in FIG. 3. Alternatively, each fluid line section 13N may include two or more nozzles 14 spaced horizontally apart with each nozzle 14 located inboard of the elbows 17 connecting adjacent fluid line sections 13N. In any case, each nozzle 14 is configured to disperse liquid L onto a separate section of the ground GN, as best shown in FIG. 15. In other words, a first nozzle 15A is configured to disperse liquid L onto a first section G1 of the ground G, a second nozzle 15B is configured to disperse liquid L onto a second section G2 of the ground G, a third nozzle 15C is configured to disperse liquid L onto a first section G3, etc., each ground section G1, G2, G3 . . . GN, being at least partially spaced horizontally from the other ground sections G1, G2, G3 . . . GN, but may be overlapping to a certain extent as depicted in FIG. 15. Further, the ground G preferably extends at least partially, and may extend completely, about the building center 1a such that the “separate” sections G1, G2, G3, G4 . . . GN of the ground G are generally adjacent to all of the building walls 2, the various ground sections GN being indicated for purposes of discussion only and generally not being physically “separated” or obviously delineated in a normal building environment.

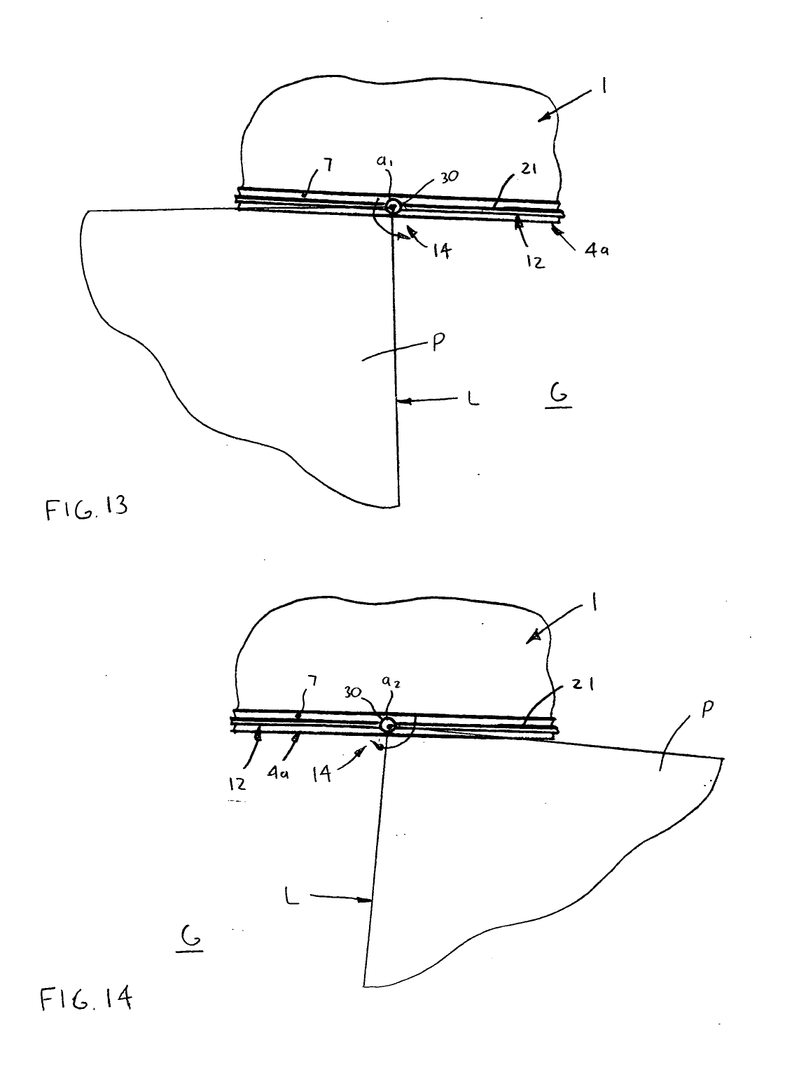

As best shown in FIG. 15, each one of the nozzles 14 is preferably configured to project liquid L onto the ground G within a generally semicircular or partially circular (i.e., wedge-like) “spray” pattern P onto the ground G. As such, each nozzle 14 is capable of projecting liquid onto a substantial section of the ground surface S_{G}. However, one or more nozzles 14 may alternatively be configured to project the liquid L in a more focused, generally tubular pattern P (FIG. 12) so as project the liquid L on a relatively smaller section of the ground G. Each of the nozzles 14 is configured to disperse the liquid L in a diverging stream S having an angle of divergence A_{S} and a width w_{W} (FIGS. 11 and 12). Preferably, one or more of the nozzles 14 is adjustable to vary the divergence angle A_{S}, and thus the stream width w_{S}, so as to thereby vary the amount of surface area (not indicated) of the ground G covered by the liquid L. Such an adjustable nozzle 14 may be used to either focus the liquid L onto a smaller or narrower section of the ground G (see FIG. 12), thus increasing the rate or amount of saturation of the particular ground section, or to alternatively increase the dispersion of the liquid L so as to thereby increase the amount of ground area covered by the liquid stream emitted by the nozzle 14.

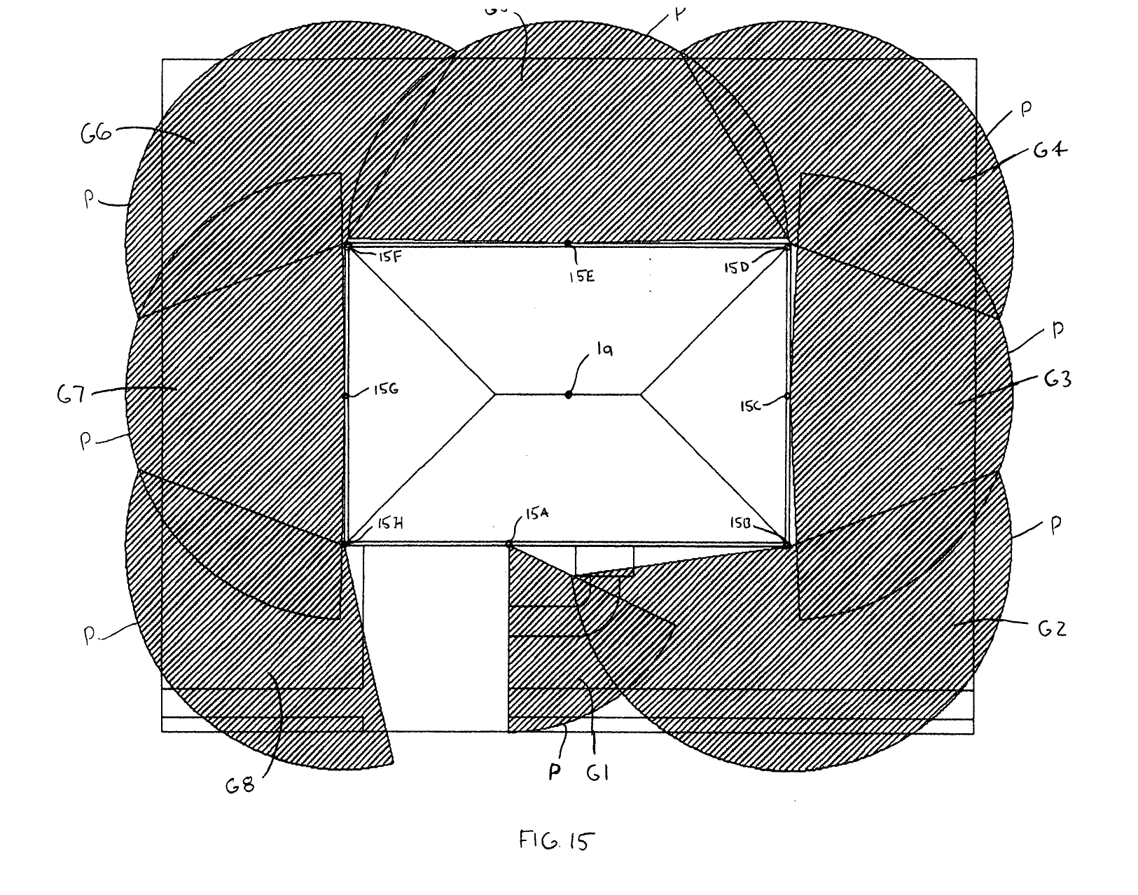

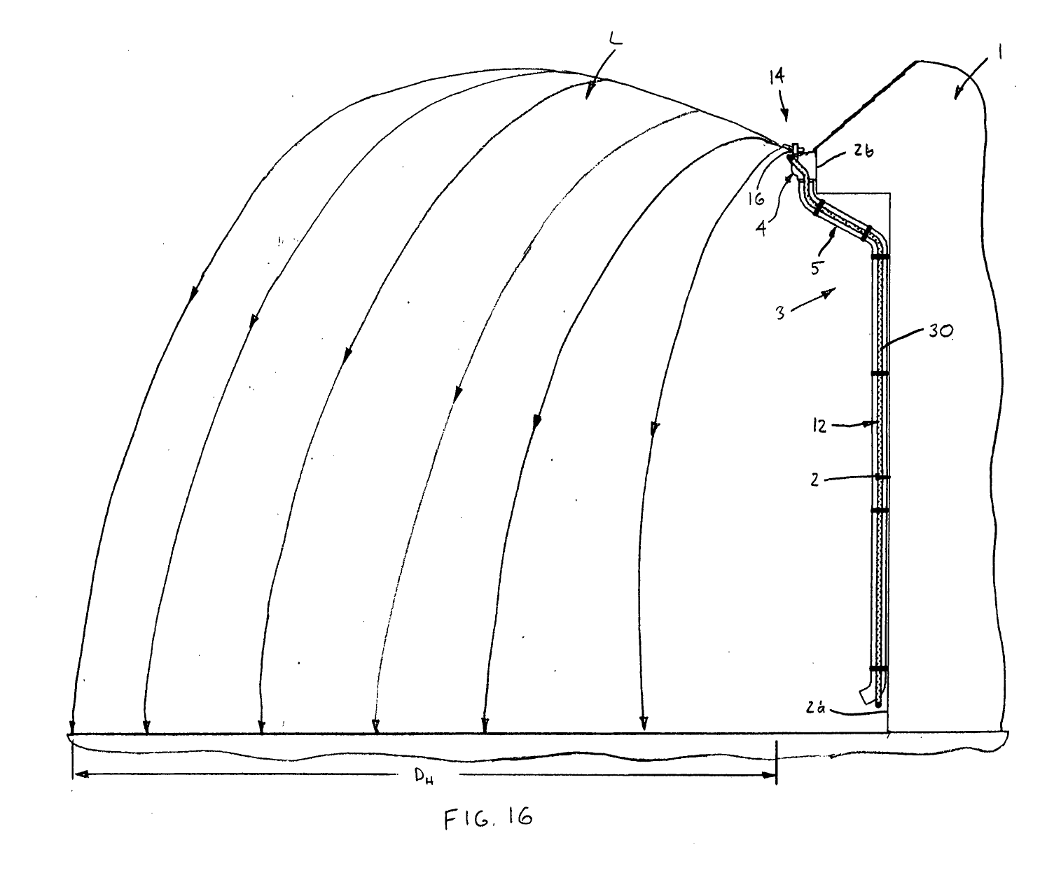

Referring now to FIGS. 4, 7, 13 and 14, one or more (or all) of the nozzles 14 may be configured to angularly displace about a generally vertical axis 14a, preferably by means of pressure of the liquid within the nozzle 14 and/or fluid line 12 driving a displacement mechanism, such as a gear train, a cam mechanism, a ratchet mechanism, etc. (none indicated). As such, the liquid L is projected from the nozzle 14 onto varying sections of the ground G, thereby increasing the total ground surface area S_{G} covered by each such nozzle 14. More specifically, such movable or pivotable nozzle(s) 14 are each displaceable between first and second angular positions a₁, a₂ about the axis 14a (see FIGS. 13 and 14), and are each preferably configured to periodically displace between the first and second positions a₁, a₂ when pressure of liquid within the nozzle 14 is at least a predetermined value (i.e., a specified minimum pressure). Thereby, each such nozzle 14 projects a liquid pattern P that “sweeps” back and forth across a section of the ground G. Further, the nozzles 14 may be constructed or mounted such that the axis 14a extends substantially vertically, such that the nozzle 14 emits a generally circular or partially circular spray pattern P, or may extend at an angle with respect to substantially vertical, in which case the spray pattern P is generally elliptical or partially elliptical. Furthermore, one or more of the nozzles 14 may be configured to displace from an initial position v_{I} on the vertical axis 14a and an operative position v_{O} on the axis 14a when pressure of liquid L within the particular nozzle 14 is at least a predetermined value, as indicated in FIG. 8. The nozzle operative position v_{O} is spaced generally vertically above the initial position v_{I}, such that the nozzle 14 may be disposed or stored at least partially within a gutter 4 when not in use, increasing the aesthetic appeal of the sprinkler system 10, as discussed in further detail below.

Referring particularly to FIG. 2, each wall 2 of the building 1 has a lower end 2a proximal to the ground surface S_{G} and an opposing upper end 2b spaced vertically above the ground surface S_{G}, and the fluid line 12 is preferably coupled with building 1 such that at least a section of the fluid line 12 is located at least generally proximal to at least one of the wall upper ends 2b. Most preferably, a separate section of the fluid line 12 is coupled with each wall 2 at least generally proximal to a separate one of each of the wall upper ends 2b. Thereby, the nozzle(s) 14 are located generally proximal to the wall upper ends 2b so as to space each nozzle 14 vertically above the adjacent ground upper surface S_{G}, as discussed above and in further detail below. However, the fluid line 12 may be alternatively coupled with the building 1 so as to be located more centrally on one or more of the walls 2, or even coupled with the building 1 so as to be located generally proximal to the lower end 2a of one or more walls 2.

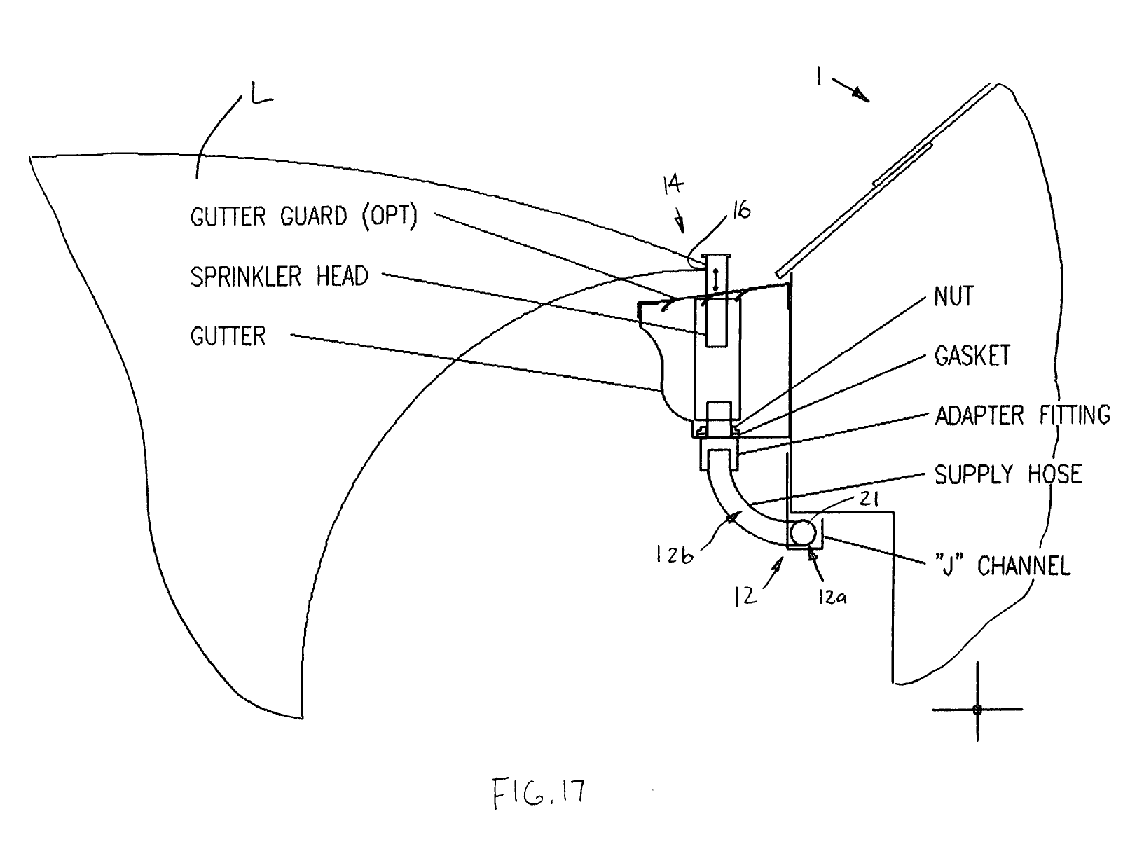

Referring to FIGS. 2, 4-5 and 16, the sprinkler system 10 preferably further comprises at least one and preferably a plurality of connectors 18 configured to couple the fluid line 12 and/or one or more nozzles 14 with the building 1. The connectors 18 are connected with the building 1 such that the nozzle(s) 14 are preferably spaced a substantial vertical distance D_{V} above the ground upper surface S_{G}, as discussed above. By positioning the nozzles 14 a substantial distance above the ground surface S_{G}, each nozzle 14 is capable of project the liquid L a greater horizontal distance D_{H} (FIG. 16) for a given fluid pressure, and thus discharge velocity, of the liquid L exiting each nozzle port 16. Thus, the “elevated” nozzles 14 are able to cover a larger portion of ground surface surrounding the building as compared with a similar nozzle operating under similar pressure but located proximal to the ground surface S_{G} as with a conventional sprinkler system. Further, by connecting the fluid line 12 and the nozzles 14 with the building 1, the sprinkler 10 is relatively easy to install and eliminates the need to dig up the ground G as required with previously known sprinkler systems 10.

Referring to FIGS. 3-5, a primary advantage of the sprinkler system 10 of the present invention is realized with a building 1 having a drainage system 3 that includes a gutter 4, which preferably includes a plurality of sections or gutter pipes 4a, and one or more downspouts 5, as would be the case with a conventional house. When used with such a building 1, the fluid line 12 is preferably disposed within and/or connected with the gutter 4, i.e., by means of the connector(s) 18, such that the gutter 4 provides a convenient and aesthetically pleasing mount for at least a portion of the sprinkler system 10, as discussed in further detail below. Thus, the fluid line 12 and the one or more nozzles 14 are preferably coupled with the building 1 through a more direct connection with the gutter 4 and/or other components of the drainage system 3.

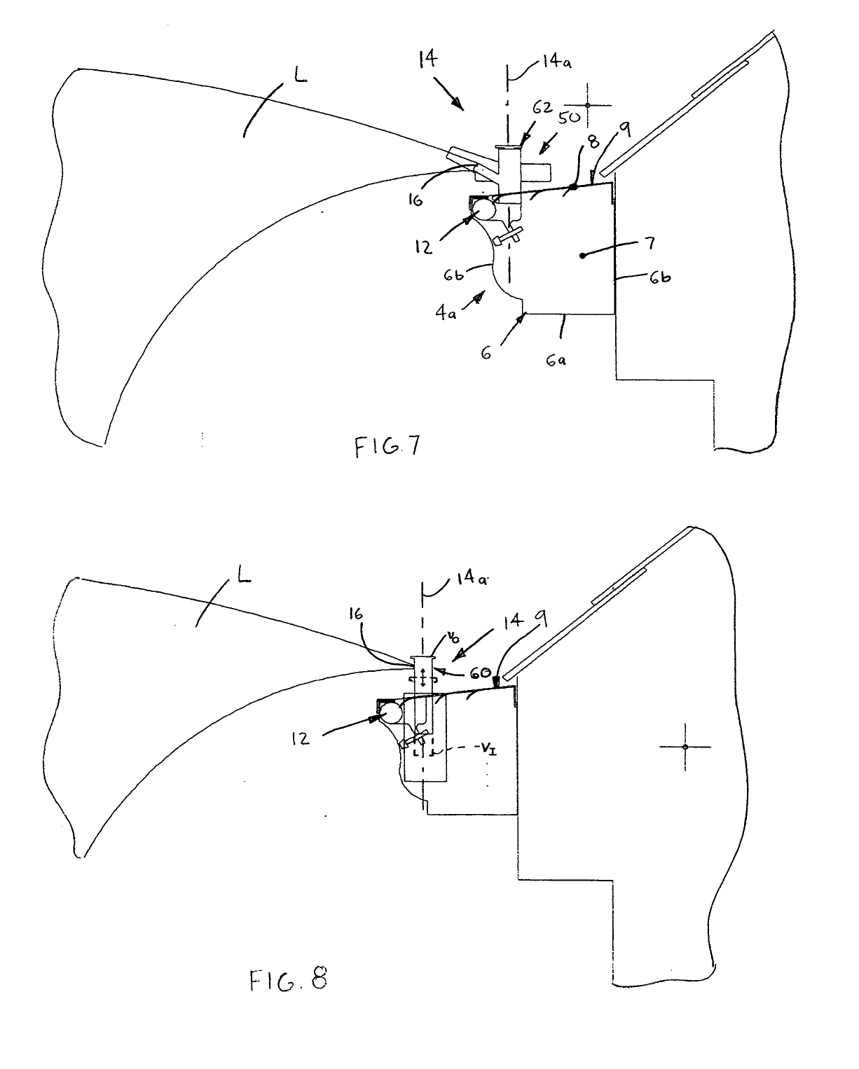

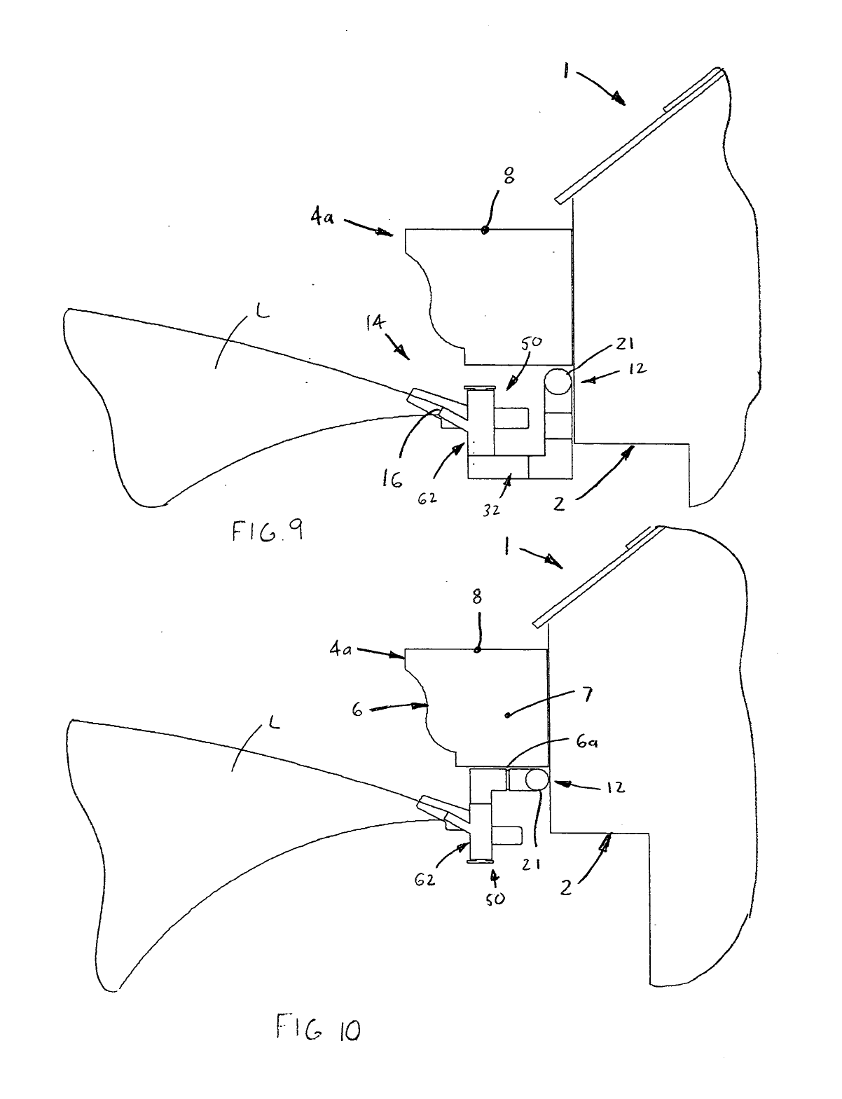

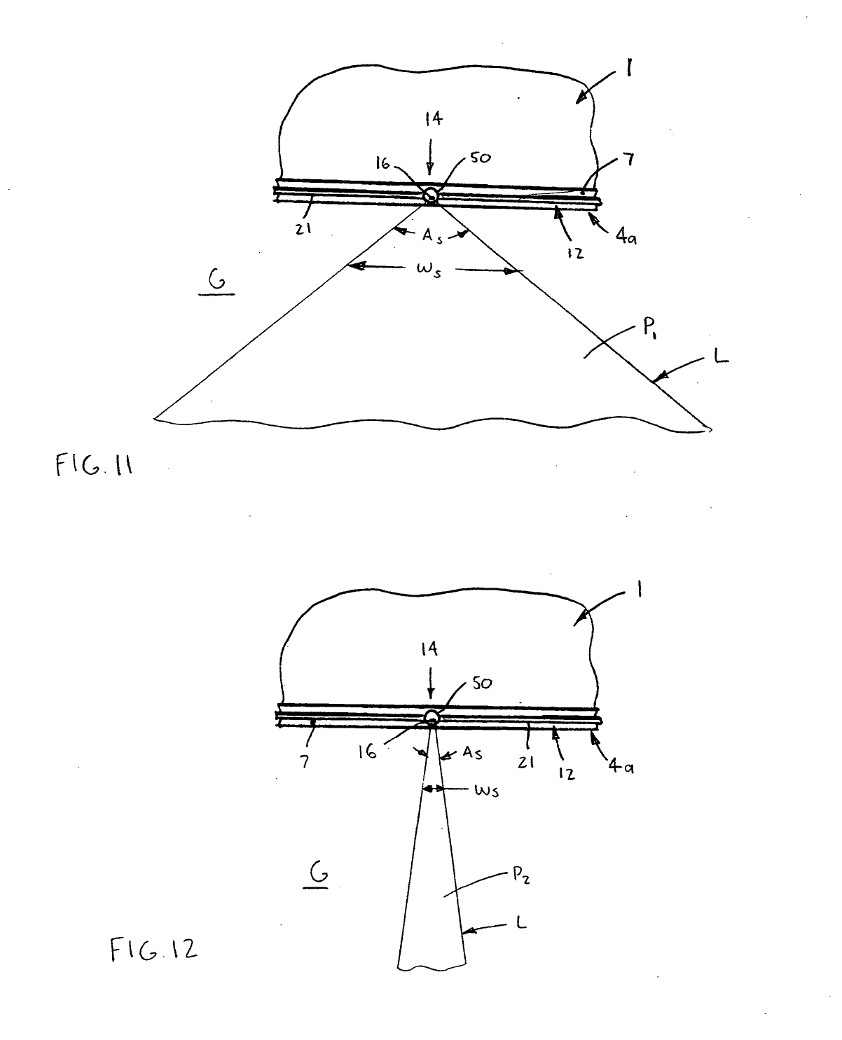

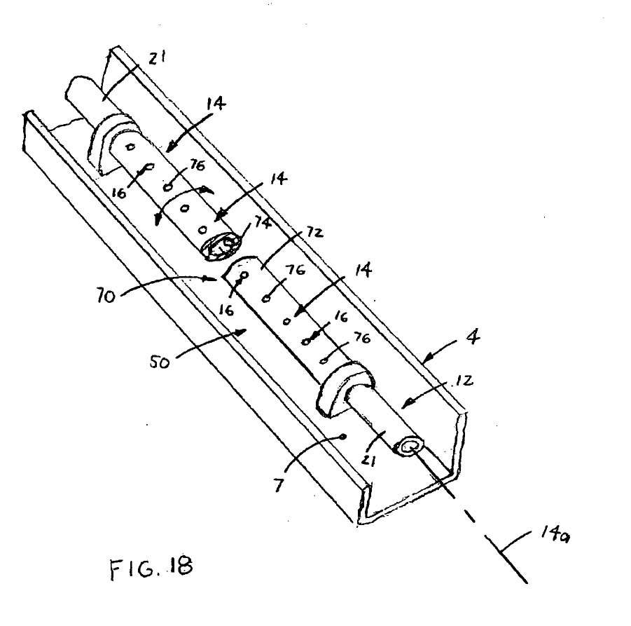

More specifically, each gutter pipe 4a has an elongated body 6 with an interior channel 7 and an upper elongated opening 8 extending into the interior channel 7. Preferably, the gutter body 6 has a bottom wall 6a and two spaced apart, generally parallel side walls 6b, with the outer sidewall 6b preferably having a generally rectangular lip 6c defining an interior channel 6d. Preferably, the gutter 4 includes a barrier or “gutter guard” 9 partially or completely covering the opening 8, as best shown in FIGS. 7 and 8, for preventing leaves and other debris from entering the gutter channel 7. With such a gutter structure, the fluid line 12 is preferably either generally disposed within the channel 7 (FIGS. 3-5, 7 and 8), most preferably within the lip channel 6d, or attached to an external surface of one of the walls 6a or 6b of the gutter body 6 (FIG. 10). Alternatively, the fluid line 12 may be primarily directly attached or mounted to the building 1, as shown in FIG. 17, with a connective portion 12b of the fluid line 12 extending from a main fluid line portion 12a to each nozzle 14.

In those constructions in which the fluid line 12 is disposed within the gutter channel 7, the nozzle 14 is preferably at least partially disposed within the channel 7, so as to minimize the visual exposure of the sprinkler system 10. However, the nozzle(s) 14 may alternatively be completely spaced above (or below) the gutter body 6. Further, with the gutters 4 having the preferred gutter guard 9, the nozzle(s) 14 is preferably disposed at least partially below the guard 8, as shown in FIGS. 7 and 8, with at least an upper portion of the nozzle 14 carrying the discharge port 16 being disposable above the guard 9. Furthermore, the components 12 and/or 14 of the sprinkler system 10 may alternatively be directly coupled with or attached to the building 1, as shown in FIGS. 9 and 17.

Referring to FIGS. 2-5, the gutter 4 is preferably constructed so as to include at least two or more sections/pipes 4a each mounted at least generally proximal to the upper end 2b of separate one of the building walls 2 and the fluid line 12 extends through at least a portion of each one of the two or more gutter pipes 4a. Preferably, the fluid line 12 includes a plurality of sections 20, most preferably connected-together pipes 21, each disposed within one of the gutter pipes 4a, as described in further detail below. Further, the sprinkler system 10 comprises at least two of the nozzles 14 each disposed within a separate one of the gutter sections/pipes 4a, and preferably includes a plurality of nozzles 14 connected with a separate fluid line pipe 21. As such, the sprinkler system 10 is capable of projecting liquid L onto the ground G adjacent to at least a portion of the building perimeter, and most preferably onto the ground G about the entire building perimeter, as described above and in further detail below.

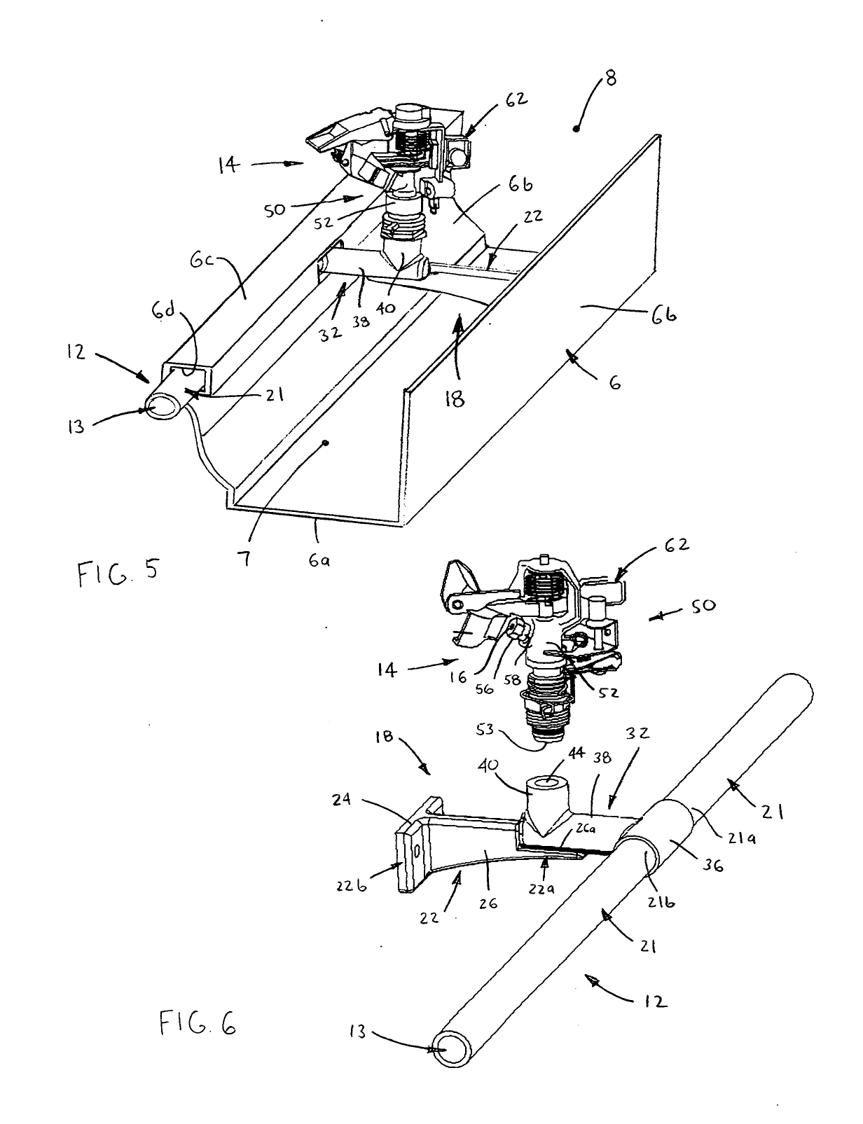

Referring to FIGS. 5 and 6, each connector 18 preferably includes at least one bracket 22 having a first end 22a connected with the either the fluid line 12 or a nozzle 14, most preferably to a riser pipe 32 of the fluid line 12, as described below, and a second end 22b connected with the building 1. Most preferably, the second end 22b of each bracket 22 is connected with the gutter 4, and is most preferably attached to the inner surface of one of the walls 6a, 6b of a gutter pipe body 6. Further, the sprinkler system 10 preferably includes a plurality of the brackets 22 spaced apart horizontally along at least a portion of the fluid line 12 so as to mount the fluid line 12 to and/or within the gutter 4. As best shown in FIG. 6, in a presently preferred embodiment, each bracket 22 includes a generally rectangular base 24 mounted to a section of the gutter body 6 and an elongated, generally cantilever-like support arm 26 extending from the base 24 and having a recessed portion 26a configured to receive and support a portion of one riser pipe 32. However, the brackets 22 or the connectors 18 may be formed in any other appropriate manner capable of mounting the fluid line 12 to the building 1 and the scope of the present invention is in no manner limited to a particular connector structure.

Referring to FIGS. 2-6 and 16, the fluid line 12 preferably includes a plurality of elongated main pipes 21, a plurality of generally T-shaped connector pipes or “risers” 32 each extending between (and fluidly connecting) one of the main pipes 21 and one of the nozzles 14, and one or more elbows 17 connecting adjacent pairs of main pipes 21. Preferably, the fluid line 12 includes a both a plurality of generally-horizontal main pipes 21 disposed within and/or attached to the gutter 4 and at least one and preferably a plurality of generally vertical main pipes 30 disposed within or attached to a downspout 5 (see FIGS. 2 and 16). The horizontal main pipes 21 preferably extend about all four or more walls 2 of the building 1, but may extend along three or less walls 2, and one or more vertical pipes 30 extend between the ground G and at least one of the horizontal main pipes 21. As best shown in FIGS. 5 and 6, each horizontal main pipe 21 is preferably formed having generally circular cross-sections and has opposing axial ends 21a, 21b each connected with one of the risers 32, an elbow 17, or other appropriate coupling.

Furthermore, each riser 32 preferably has a coupler pipe section 36 configured to connect with at least one main pipe 21, a main passage section 38, and a support stem 40 configured to receive and/or support one nozzle 14 on the riser 32, as best shown in FIG. 6. The riser coupler section 36 is configured to receive the end 21a or 21b of at least one adjacent horizontal pipe 21, most preferably within opposing circular openings (not indicated). The riser main passage section 38 preferably extends generally perpendicularly, and preferably horizontally, from the coupler section 36, although the main section 38 may alternatively extend generally vertically (and thus function as a “true” riser), or be arranged at angle between vertical and horizontal. Also, the support stem 40 has an outlet port 44 (FIG. 6) fluidly connectable with the nozzle 14 and is preferably directly attached to a sprinkler head 50, as described below. Although such a generally T-shaped riser 32 as described above is presently preferred, each riser 32 may alternatively be constructed in any other appropriate manner. Further, the fluid line 12 may be alternatively constructed without any risers 32, such that each nozzle 14 is directly attached to a main pipe 21.

Referring now to FIGS. 5 and 6, the sprinkler system 10 preferably comprises a plurality of sprinkler heads 50 each providing one or more of the nozzles 14. Each sprinkler head 50 preferably includes a body 52 connected with the fluid line 12, preferably with one of the risers 32, and configured to support the nozzle 14. Preferably, the sprinkler body 52 includes an inlet port 53 fluidly connected with the fluid line 12 (i.e., through the riser outlet port 44) and an interior channel or cavity (not depicted) for receiving the liquid from the flow line 12, preferably directly from the associated riser outlet port 44. As best shown in FIG. 6, each nozzle 14 preferably includes a head 56 providing one or more of the discharge ports 16 and a coupler stem 58 either at least partially disposed within or attached to the sprinkler head body 52 and configured to fluidly connect the one or more discharge ports 16 with the head channel or cavity.

Further, each sprinkler head 50 may be constructed or formed as a spray head 60 (FIG. 8), a rotor head 62 (FIGS. 4-7, 9 and 10), or any other known type of sprinkler head. When constructed as a spray head 60, the one or discharge ports 16 are located in a fixed position relative to the sprinkler head body 52 and continuously projects liquid L onto a specific portion of the ground. However, when constructed a rotor head 62, the sprinkler head 50 causes the nozzle discharge port 16 to reciprocally rotate or pivot about the nozzle axis 14a such that the discharge port(s) 16 project a stream of liquid L that sweeps the ground G so as to project the liquid on varying sections thereof. Furthermore, the elevated sprinkler system 10 may either include sprinkler heads 50 all constructed as a single head type 60, 62, etc. or any desired combination of head types.

Referring specifically to FIG. 18, each sprinkler head 50 may also be constructed or formed as a sprayer bar 70 including an elongated tube 72 with a central bore 74 fluidly connected with the fluid line 12 and a plurality of holes 76 each fluidly coupled with the bore 74. Each hole 76 provides a separate discharge port 16, such that sprayer bar 70 provides a plurality of the nozzles 14. Preferably, the one or more sprayer bars 70 of the sprinkler system 10 are each configured to reciprocally rotate or pivot about a generally horizontal axis 14a, most preferably by means of a gear train mechanism (not depicted). As such, the discharge ports 16 each project a stream of liquid L that moves from ground sections proximal to the building 1 toward ground sections distal from the building, and vice versa, in a periodic manner. Thus, each sprayer bar 70 is formed at least generally similar to a commercially available oscillating sprinkler. Such a sprayer bar 70 provides the potential benefits of having a more “rectangular” liquid coverage pattern on the ground G and being generally quieter than a typical “impact” driven rotor head 62 as discussed above.

Although the sprinkler system 10 preferably includes conventional sprinkler heads 50 providing the nozzles 14 and fluidly coupling the discharge port(s) 16 with the fluid line 12, the one or more nozzles 14 may be constructed in any other appropriate manner or/and may alternatively be coupled with the fluid line 12 by another appropriate means. For example, one or more nozzles 14 may be each provided by a separate orifice member (not shown) directly attached to the one of the pipes 21, by a specially fabricated nozzle movably or fixedly connected with the fluid line 12, etc. The scope of the present invention encompasses these and any other structure of the nozzle(s) 14 capable of functioning such that the sprinkler system 10 operates or performs generally as described herein.

The elevated sprinkler system 10 of the present invention has a number of advantages over previously known sprinkler systems. The present sprinkler system 10 may be readily installed to and/or within an existing drainage system, thus eliminating the need to dig trenches in a lawn and the necessity of re-growing grass over such trenches. The sprinkler system 10 may utilize relatively less expensive impact types of sprinkler heads, the use of which is normally avoided in lawn sprinkler systems due to the potential damage by lawnmowers. Further, being elevated above the ground surface, the nozzles 14 are capable of projecting liquid L at a greater distance for given water pressure as compared with ground located nozzles/sprinkler heads. Also, potential obstructions to the nozzle “spray path” is eliminated or reduced as the nozzles can project the liquid over obstructions such as trees, bushes, garden walls, fences, hills etc, and substantially eliminates the need to account for the spray coverage of the sprinkler system when planning future landscaping projects. Furthermore, the nozzles 14 of the elevated sprinkler system 10 are out of reach of children who may potentially block the nozzles, as is the case with in-ground sprinkler systems, which may create wet spots that potentially damage to the lawn.

Regarding maintenance considerations, the elevated sprinkler system 10 is very easy to drain down and may be installed with a valve (not depicted) that automatically drains down the fluid line 12 and nozzles 14 after each use, thereby preventing potential freezing damage to such components. The various components of the system 10 are located away from potential damage by lawn mowers or children and are free from contamination by dirt, grass, etc., which is particularly problematic with sprinkler heads. Additionally, the sprinkler system 10 may be readily adapted to project or disperse lawn treatment liquids (e.g., fertilizer, weed killer, etc.) onto a lawn. Further, the sprinkler system 10 may incorporate one or more dump valves (none shown) in the fluid line 12 that are each configured to project water into the gutter 4 so as to flush debris out of the gutter 4 and through the down spout 5. Furthermore, the elevated sprinkler system 10 may additionally include one or more nozzles 14 that are each configured as a misting unit (none depicted) and located above or around an outdoor seating area (not indicated). Such misting units may be manually or automatically activated to project a mist of water to cool the seating area. Finally, as discussed above, the elevated sprinkler system 10 may be connectable to a source of firefighting substance such that the nozzles 14 project the substance about the building perimeter to prevent fire from reaching the building 1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

I claim:

1. A sprinkler system for projecting a liquid from a source onto ground adjacent to a building, the ground having an upper surface, the sprinkler system comprising:
a fluid line coupled with the liquid source and having a flow passage; and
a nozzle coupled with the fluid line, having a discharge port, and being fluidly connected with the flow passage such that liquid in the passage flows through the discharge port, at least one of the nozzle and the fluid line being configured to couple with the building such that the nozzle discharge port is spaced generally vertically above the ground upper surface, the nozzle being configured to direct liquid discharged from the flow line generally onto the ground.

2. The sprinkler system as recited in claim 1 wherein the ground includes grass and the source of liquid is a water source, the fluid line being fluidly coupled with the water source and the nozzle being configured to project water onto the grass.

3. The sprinkler system as recited in claim 1 further comprising at least one connector configured to couple at least one of the fluid line and the nozzle with the building such that the at least one nozzle is spaced a substantial vertical distance above the ground upper surface.

4. The sprinkler system as recited in claim 3 wherein the building has a gutter and the connector includes at least one bracket having a first end connected with the one of the fluid line and the nozzle and a second end connected with one of the building and the gutter.

5. The sprinkler system as recited in claim 4 wherein the gutter has three wall sections defining an interior channel and an upper open end, the bracket second end being attached to one of the three wall sections and the nozzle is one of at least partially disposed within the gutter channel and disposed externally of the channel.

6. The sprinkler system as recited in claim 1 wherein:
the building has at least one gutter with an elongated body having an exterior channel; and
the fluid line is at least one of connected with the gutter and disposed within the interior channel of the gutter.

7. The sprinkler system as recited in claim 6 wherein the at least one gutter has an elongated opening extending into the interior channel and the nozzle one of extends through the gutter opening and is spaced from the gutter opening.

8. The sprinkler system as recited in claim 7 wherein the building has a plurality of walls each having an upper end and the gutter has at least two sections each mounted at least generally proximal to the upper end of a separate one of the walls, the fluid line extends through at least a portion of each one of the two gutter sections, and the sprinkler system comprises at least two nozzles each disposed within a separate one of the gutter sections.

9. The sprinkler system as recited in claim 1 wherein the building has a center, the fluid line extends at least partially about the building center, and the sprinkler system comprises a plurality of the nozzles spaced generally horizontally apart and generally circumferentially about the building center, the nozzles being configured to discharge the liquid generally away from the building center.

10. The sprinkler system as recited in claim 1 wherein the building has a plurality of walls each having a lower end proximal to the ground surface and an opposing upper end spaced above the ground surface, the fluid line being coupled with building such that at least a section of the fluid line is located at least generally proximal to at least one of the wall upper ends.

11. The sprinkler system as recited in claim 1 wherein the nozzle is a first nozzle and the sprinkler system further comprises a second nozzle connected with the fluid line, the other nozzle being spaced generally horizontally from the first nozzle.

12. The sprinkler system as recited in claim 11 wherein the first nozzle is configured to disperse liquid onto a first section of the ground and the second nozzle is configured to disperse liquid onto a second section of the ground, the second ground section being at least partially spaced from the first ground section.

13. The sprinkler system as recited in claim 11 wherein the nozzle is configured to at least one of:
project fluid onto the ground within a generally triangular pattern onto the ground; and
disperse the fluid in a diverging stream having a width, the nozzle being adjustable to vary the stream width so as to vary an amount of surface area of the ground covered by the liquid.

14. The sprinkler system as recited in claim 1 wherein the nozzle is configured to angularly displace about a generally vertical axis between first and second angular positions such that the liquid is projected from the nozzle onto varying sections of the ground.

15. The sprinkler system as recited in claim 14 wherein the nozzle is configured to periodically displace between the first and second angular positions when pressure of liquid within the nozzle is at least a predetermined value and to displace from an initial position on the vertical axis and an operative position on the axis when pressure of liquid within the nozzle is at least a predetermined value, the operative position being spaced generally vertically above the initial position.

16. The sprinkler system as recited in claim 1 wherein the nozzle is configured to displace from an initial position on the vertical axis and an operative position on the axis when pressure of liquid within the nozzle is at least a predetermined value, the operative position being spaced generally vertically above the initial position.

17. The sprinkler system as recited in claim 1 wherein the fluid line includes at least one generally horizontal section spaced vertically above the ground surface and at least one generally vertical section extending between and fluidly coupling the horizontal section and the liquid source.

18. The sprinkler system as recited in claim 17 wherein the building has at least one wall having a lower end proximal to the ground surface and an upper end spaced above the ground surface, the fluid line horizontal section being disposed at least generally proximal to the wall upper end.

19. The sprinkler system as recited in claim 18 wherein the building includes a plurality of walls and the fluid line horizontal section includes a plurality of connected pipes, each pipe being coupled with a separate one of the building walls.

20. The sprinkler system as recited in claim 19 wherein the building includes a gutter assembly with a plurality of gutter sections each mounted to a separate one of the walls, each fluid line pipe being at least one of connected with and disposed within at least one of the gutter sections.

21. A sprinkler system for projecting a liquid from a source onto ground about a building, the ground having an upper surface, the sprinkler system comprising:
a fluid line coupled with the liquid source and having a flow passage;
a nozzle coupled with the fluid line, having a discharge port, and being fluidly connected with the flow passage such that liquid in the passage flows through the discharge port, the nozzle being configured to direct liquid discharged from the flow line generally onto the ground; and
at least one coupler configured to connect at least one of the pipe and the nozzle with the building such that the nozzle is spaced a substantial vertical distance above the ground upper surface.

22. A homestead comprising:
a lot including ground with an upper surface and grass on the ground upper surface;
a building disposed on the lot; and
a sprinkler system including:
a fluid line coupled with a liquid source and having a flow passage; and
a nozzle coupled with the fluid line, having a discharge port, and being fluidly connected with the flow passage such that liquid in the passage flows through the discharge port, at least one of the nozzle and the fluid line being configured to couple with the building such that the nozzle discharge port is spaced generally vertically above the ground upper surface, the nozzle being configured to direct liquid discharged from the flow line generally onto the grass.
